(19) United States
(12) Patent Application Publication
(10) Pub. No.: US 2024/0121509 A1
(43) Pub. Date: Apr. 11, 2024

(54) IN-VEHICLE DEVICE, NON-TRANSITORY COMPUTER-READABLE STORAGE MEDIUM STORING CONTROL PROGRAM, AND ACTIVATION METHOD

(71) Applicant: DENSO CORPORATION, Kariya-city (JP)

(72) Inventors: Makoto MANABE, Kariya-city (JP); Shigeru KAJIOKA, Kariya-city (JP); Makiko TAUCHI, Kariya-city (JP); Masato MIYAKE, Kariya-city (JP)

(21) Appl. No.: 18/390,009

(22) Filed: Dec. 20, 2023

Related U.S. Application Data
(63) Continuation of application No. PCT/JP22/26366, filed on Jun. 30, 2022.

(30) Foreign Application Priority Data
Jul. 2, 2021 (JP) 2021-110906

(51) Int. Cl. H04N 23/661; B60R 25/30; G06F 9/445

(52) U.S. Cl. CPC H04N 23/661; B60R 25/305; G06F 9/445

(57) ABSTRACT

An in-vehicle device is configured to access a cloud via a communication unit, and includes: a controller that includes at least one physical core; a first unit configured to be operated by the controller and control a sensor to generate detection data; and a second unit configured to be operated by the controller and execute a process based on the detection data.

### CROSS REFERENCE TO RELATED APPLICATIONS

The present application is a continuation application of International Patent Application No. PCT/JP2022/026366 filed on Jun. 30, 2022, which designated the U.S. and claims the benefit of priority from Japanese Patent Application No. 2021-110906 filed on Jul. 2, 2021. The entire disclosures of all of the above applications are incorporated herein by reference.

### TECHNICAL FIELD

The present disclosure relates to an in-vehicle device capable of accessing a cloud, a non-transitory tangible storage medium storing a control program, and an activation method for the in-vehicle device.

### BACKGROUND

As a comparative example, an in-vehicle device has been known that is equipped with a general-purpose OS (hereinafter referred to as GPOS) that does not have real-time functionality. Furthermore, by using such an in-vehicle device, it has been proposed to control sensors such as cameras using an app that operates on GPOS and provide various services. The “app” is an abbreviation for an application.

### SUMMARY

An in-vehicle device is configured to access a cloud via a communication unit, and includes: a controller that includes at least one physical core; a first unit configured to be operated by the controller and control a sensor to generate detection data; and a second unit configured to be operated by the controller and execute a process based on the detection data.

### BRIEF DESCRIPTION OF DRAWINGS

FIG. 1 is a block diagram showing a configuration of a mobility IoT system according to a first embodiment.

FIG. 2 is a block diagram showing a data collection device according to a first embodiment.

FIG. 3 is a block diagram showing a configuration of a program of the data collection device.

FIG. 4 is a flowchart showing processes at an activation time of the data collection device according to the first embodiment.

FIG. 5 is a block diagram showing a connection state when a plurality of ECUs including the data collection device are mounted on a vehicle.

FIG. 6 is a block diagram showing a configuration of a program of the data collection device according to a second embodiment.

FIG. 7 is a flowchart showing processes at an activation time of the data collection device according to the second embodiment.

### DETAILED DESCRIPTION

However, as a result of detailed study by the inventors, it has been found that the GPOS takes time to initialize. Therefore, when the sensor is controlled by the app on GPOS, it may be difficult to activate the sensor early at an activation time of the in-vehicle device. Therefore, when controlling sensors with such an app, it may be difficult to provide highly urgent services such as suspicious person detection immediately after the in-vehicle device is activated.

One example of the present disclosure provides a technology for executing a process based on sensor detection data generated earlier after activation of an in-vehicle device. According to one example embodiment, an in-vehicle device is configured to access a cloud via a communication unit, and includes: a controller that includes at least one physical core; a first unit configured to be operated by the controller and control a sensor to generate detection data; a second unit configured to be operated by the controller and execute a process based on the detection data; and a firmware configured to be operated by the controller, be activated in response to an activation signal, and execute an initialization process. When activated in response to the activation signal, the firmware activates the first unit before completion of the initialization process and activates the second unit after the completion of the initialization process. When activated by the firmware, the first unit activates the sensor and controls the sensor to generate the detection data. When activated by the firmware, the second unit executes the process based on the detection data generated after activation of the first unit and before activation of the second unit.

According to the above configuration, the first unit can be activated early after the activation signal occurred, and generation of detection data by the sensor can start. Then, the second unit performs executes a process based on the detection data generated after the first unit is activated and before the second unit is activated. Therefore, after the activation of the in-vehicle device, it is possible to execute the process based on the sensor detection data generated earlier.

Note that a control program that causes a computer to operate as the in-vehicle device may be configured. Similar effects can be obtained by operating the computer according to such a control program. Further, in the in-vehicle device described above, a procedure performed when the firmware is activated in response to an activation signal may be provided as an activation method. According to the activation method, the similar effect can be obtained.

According to another example embodiment, an in-vehicle device is configured to access a cloud via a communication unit, and includes: a first controller that includes at least one physical core and is configured to stop activation in a low power mode; a first unit configured to be operated by the first controller and control a sensor to generate detection data; a second unit configured to be operated by the first controller and execute a process based on the detection data; and a second controller configured to detect a predetermined signal in the low power mode. When detecting the predetermined signal, the second controller activates the first unit. When activated by the second controller, the first unit activates the second unit and the sensor, and controls the sensor to generate the detection data. When activated by the first unit, the second unit executes the process based on the detection data generated after activation of the first unit and before activation of the second unit.

According to the above configuration, the first unit can be activated early after the activation signal occurred, and generation of detection data by the sensor can start. Then, the second unit executes a process based on the detection data generated after the first unit is activated and before the second unit is activated. Therefore, after the activation of the in-vehicle device, it is possible to execute the process based on the sensor detection data generated earlier.

Note that a control program may be configured to cause a computer to operate as the first controller of the in-vehicle device. The similar effect can be obtained by operating the computer according to such a control program. Further, in the in-vehicle device described above, a procedure performed when the first unit is activated in response to an activation signal may be provided as an activation method. According to the activation method, the similar effect can be obtained.

Hereinafter, embodiments of the present disclosure will be described with reference to the drawings.

### First Embodiment

### 1. Overall Configuration

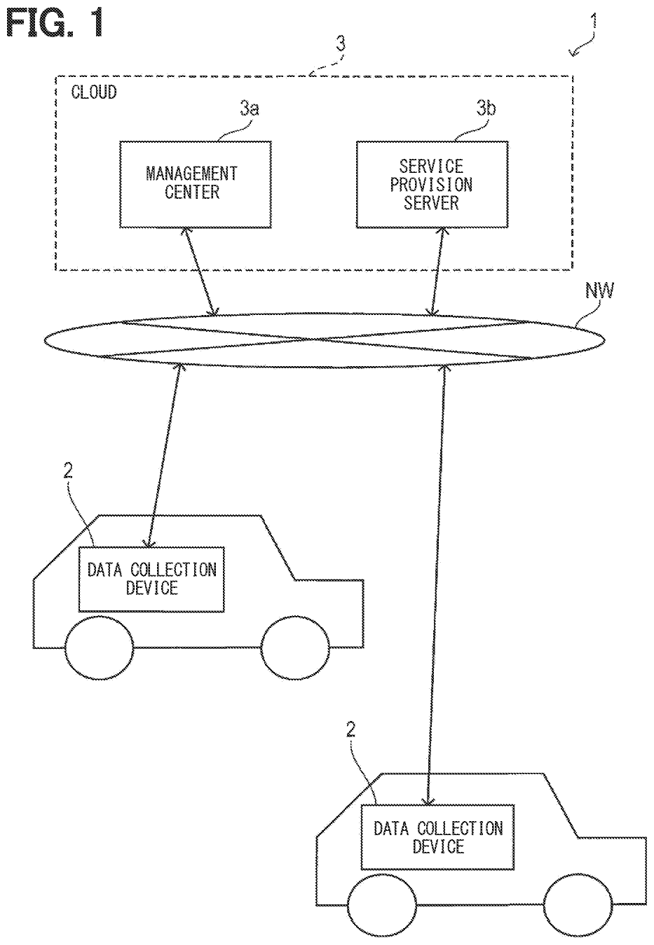

As shown in FIG. 1, a mobility IoT system 1 of a first embodiment includes a plurality of data collection devices 2 that can access a cloud 3 via a wide area wireless communication network NW, and a management center 3a and a service providing server 3b provided by the cloud 3. The IoT is an abbreviation for Internet of Things.

The data collection device 2 is mounted on a vehicle and has a function of executing data communication with the management center 3a. Hereinafter, the vehicle on which the data collection device 2 is mounted is referred to as a subject vehicle.

The management center 3a manages the mobility IoT system 1. The management center 3a has a function of executing data communication between the plurality of data collection devices 2 and the service provision server 3b via the wide area wireless communication network NW.

The service provision server 3b is, for example, a server for providing services for managing operations of vehicles. The mobility IoT system 1 may include a plurality of service provision servers having different service contents.

### 2. Configuration of Data Collection Device

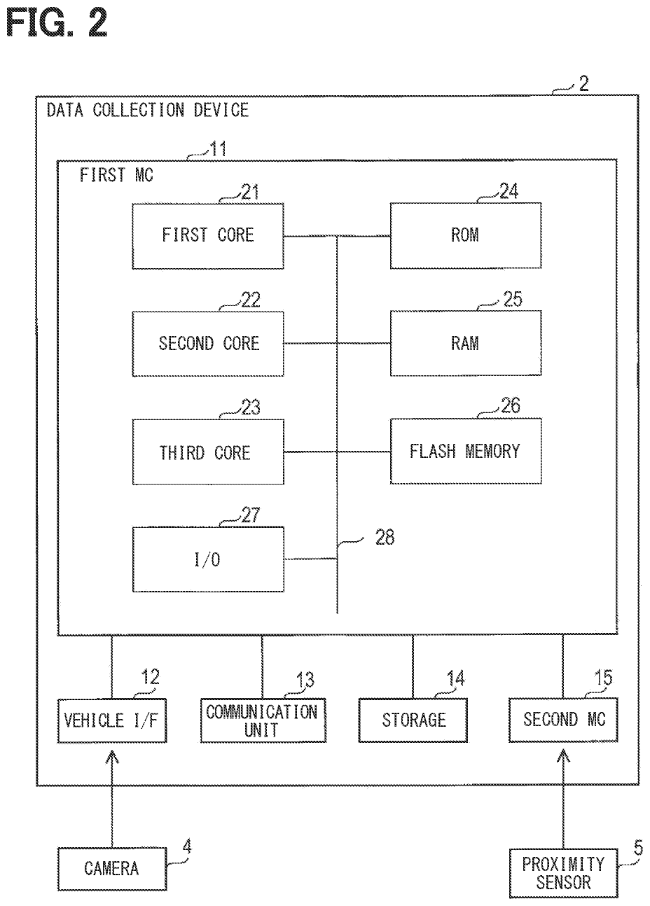

As shown in FIG. 2, the data collection device 2 includes a first MC 11, a vehicle I/F 12 (vehicle interface 12), a communication unit 13, a storage 14, and a second MC 15. The MC is an abbreviation for microcontroller.

The first MC 11 includes first to third cores 21, 22, 23 which are physical cores, a ROM 24, a RAM 25, a flash memory 26, an input-output unit 27, and a bus 28.

Various functions of the first MC 11 are implemented by the first to third cores 21 to 23 executing a control program stored in a non-transitory tangible storage medium. In this example, the ROM 24 and the RAM 25 correspond to the non-transitory tangible storage medium storing the control program. A method corresponding to the control program is performed by executing the control program. Some or all of the functions implemented by the first to third cores 21 to 23 may be implemented by hardware such as at least one IC.

The flash memory 26 is a data rewritable nonvolatile memory.

The input-output unit 27 is a circuit for inputting and outputting data between an outside of the first MC 11 and the first to third cores 21 to 23.

The bus 28 connects the first to third cores 21 to 23, the ROM 24, the RAM 25, the flash memory 26, and the input-output unit 27 so that data can be input and output to and from each other.

The vehicle I/F 12 is an input-output circuit for inputting and outputting signals between the data collection device 2 and other electronic control units, sensors, and the like. The vehicle I/F 12 includes, for example, a power supply voltage input port, a general-purpose input-output port, a CAN communication port, an Ethernet communication port, a wireless LAN communication port, a short-range wireless communication port, a GPS communication port, and a camera communication port. The data collection device 2 is connected to the battery power source of the vehicle through the vehicle I/F 12.

The CAN communication port is a port for transmitting and receiving data in accordance with a CAN communication protocol. The Ethernet communication port is a port for transmitting and receiving data based on an Ethernet communication protocol. The CAN is an abbreviation for Controller Area Network. Both CAN and Ethernet are registered trademarks.

The CAN communication port and the Ethernet communication port are connected to other electronic control units mounted on the subject vehicle. Accordingly, the data collection device 2 can transmit and receive a communication frame to and from the other electronic control units.

The wireless LAN communication port is a port for transmitting and receiving data via a wireless LAN. The short-range wireless communication port is a port for transmitting and receiving data by a short-range wireless communication technology such as Bluetooth (registered trademark), for example. These ports are connectable to a communication controller, and the data collection device 2 transmits and receives data to and from the other electronic control units via the communication controller connected to the ports.

The GPS communication port is a port to which a device provided with a GPS is connected, and the data collection device 2 controls the GPS via the GPS communication port. The camera communication port is a port to which a camera 4 mounted on the subject vehicle is connected. The camera 4 is configured to capture the periphery of the subject vehicle and/or the inside of the subject vehicle, and the data collection device 2 controls the camera 4 via the camera communication port.

The communication unit 13 is connected to the data collection device 2 via the communication port. For example, the communication unit 13 accesses the wide area wireless communication network NW by wireless communication according to a communication standard such as LTE, and executes data communication with the cloud 3 via the wide area wireless communication network NW.

The storage 14 is a storage device for storing various data.

The second microcomputer 15 activates the first microcomputer 11 when an operation to start driving the subject vehicle (for example, an operation to turn on a power switch or a key switch) is performed. The second microcomputer 15 is configured to receive signals via the vehicle I/F 12, for example, receive information of each switch operation transmitted from another electronic control unit via the CAN communication port of the vehicle I/F 12. Further, the second microcomputer 15 is connected to a proximity sensor 5 that detects the approach of an object such as a person to the subject vehicle. The proximity sensor 5 may be, for example, a millimeter wave radar.

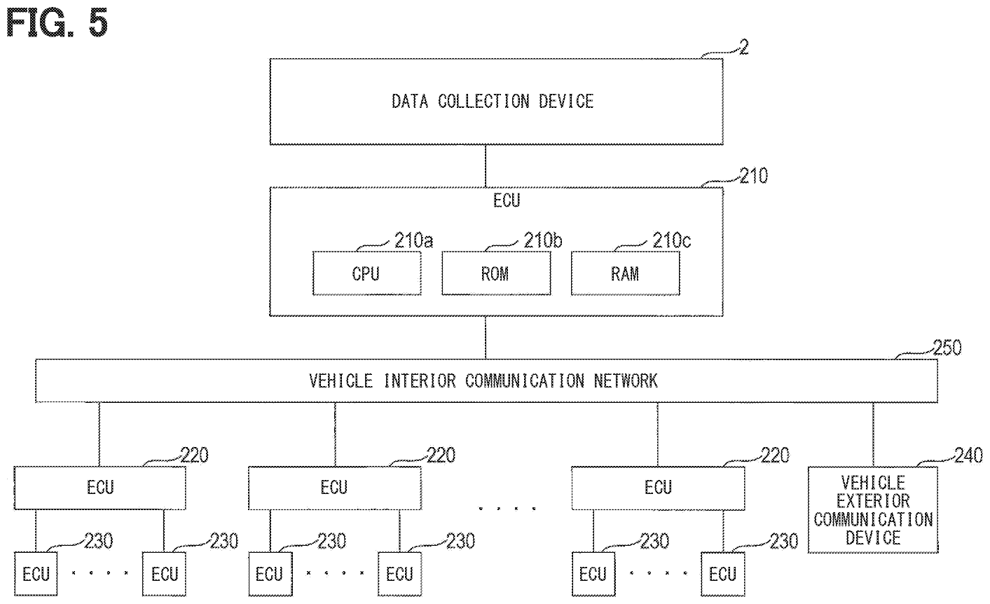

As shown in FIG. 5, one ECU 210, multiple ECUs 220, multiple ECUs 230, a vehicle exterior communication device 240, and a vehicle interior communication network 250 are mounted on the subject vehicle. The ECU is an abbreviation for electronic control unit.

The ECU 210 integrally controls the multiple ECUs 220 to execute controls in cooperation with each other in the entire vehicle. Each ECU 220 is provided for each of domains divided according to functions in the vehicle, and mainly controls the multiple ECUs 230 existing in the domain. Each ECU 220 is connected to subordinate ECUs 230 via a lower-layer network (for example, CAN) provided individually. Each ECU 220 has a function of centrally managing access authority to the subordinate ECUs 230 and executing user authentication and the like. The domains are, for example, a powertrain domain, a body domain, a chassis domain, and a cockpit domain.

The ECUs 230 connected to the ECU 220 belonging to the powertrain domain include, for example, an ECU 230 that controls an engine, an ECU 230 that controls a motor, and an ECU 230 that controls the battery.

The ECUs 230 connected to the ECU 220 belonging to the body domain include, for example, an ECU 230 that controls an air conditioner, and an ECU 230 that controls a door.

The ECUs 230 connected to the ECU 220 belonging to the chassis domain include, for example, an ECU 230 that controls braking, and an ECU 230 that controls steering.

The ECUs 230 connected to the ECU 220 belonging to the cockpit domain includes, for example, an ECU 230 that controls display of a meter and navigation, and an ECU 230 that controls an input device operable by an occupant of the vehicle.

The vehicle exterior communication device 240 executes data communication with a communication device outside the vehicle (for example, a cloud server) via the wide area wireless communication network NW.

The vehicle interior communication network 250 includes a CAN FD and Ethernet. The CAN FD is an abbreviation for CAN with Flexible Data Rate. The CAN FD connects the ECU 210 to each of the ECUs 220 and the vehicle exterior communication device 240 via a bus. The Ethernet individually connects the ECU 210 to each of the ECUs 220 and the vehicle exterior communication device 240.

The ECU 210 is an electronic control unit mainly includes a microcomputer including a CPU 210a, a ROM 210b, and a RAM 210c. Various functions of the microcomputer are implemented by the CPU 210a executing a program stored in a non-transitory tangible storage medium. In this example, the ROM 210b corresponds to the non-transitory tangible storage medium in which the program is stored. A method corresponding to the program is executed by executing the program. Some or all of the functions executed by the CPU 210a may be configured as hardware by one or multiple ICs. Further, the number of microcomputers constituting the ECU 210 may be one or more.

Like the ECU 210, the ECUs 220, the ECUs 230, and the vehicle exterior communication device 240 are each an electronic control unit mainly including a microcomputer including a CPU, a ROM and a RAM. Further, the number of microcomputers constituting each of the ECUs 220, each of the ECUs 230, and the vehicle exterior communication device 240 may be one or more. Each ECU 220 is an ECU that controls one or more ECUs 230. The ECU 210 is an ECU that controls one or more ECUs 220 or controls the ECUs 220, 230 of the entire vehicle including the vehicle exterior communication device 240.

The data collection device 2 is connected to the ECU 210 so as to perform data communication with the ECU 210. That is, the data collection device 2 receives information of the ECUs 210, 220, 230 via the ECU 210. Further, the data collection device 2 transmits a request related to vehicle control to the ECU 210 or transmits the request to the ECUs 220, 230 via the ECU 210.

### 3. Configuration of Control Program

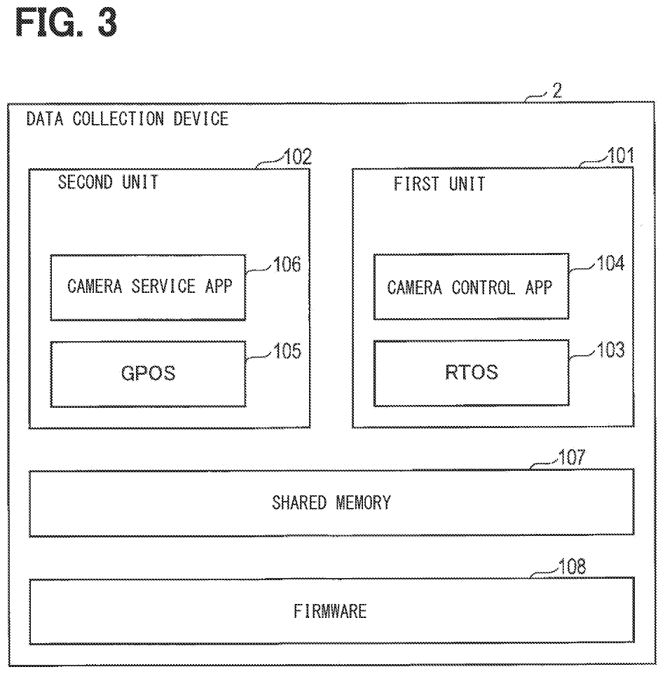

The first MC 11 of the data collection device 2 executes a control program stored in the ROM 24 or a control program loaded into the RAM 25. These control programs include first and second units 101 and 102, and a firmware 108 (see FIG. 3).

The first unit 101 is executed by the first core 21 and mainly executes processes related to hardware control. The first unit 101 includes a RTOS (real-time operating system) 103 and at least one first app. The first app mainly executes a process for controlling a device installed in the subject vehicle, and the process executed by the first application has real-time characteristics. In addition, the t operates the first app 102 so as to ensure the real-time characteristics (for example, real-time responsiveness) of the process by the first app 102.

In this embodiment, as an example, a camera control app 104 is provided as the first app. The camera control app 104 controls the camera 4 to captures the periphery of the subject vehicle and/or the inside of the subject vehicle, and stores the capture image data in the shared memory 107.

The second unit 102 is executed by the second core 22 and mainly executes a process related to providing services in cooperation with the cloud. Of course, the second unit 102 may execute a process related to the data collection device 2 and/or a service provided by a device connected to the data collection device 2, for example, without cooperating with the cloud. The second unit 102 includes a GPOS (general purpose operating system) 105 and at least one second app. The second app mainly executes a process for providing a service to a user. More specifically, the second app may execute a process for a service provided by the cloud 3, or may execute a process for a service provided without cooperating with the cloud 3. The process executed by the second app does not require a high real-time responsiveness. The GPOS 105 is basic software that operates the second app without ensuring the high real-time responsiveness. For example, Linux (registered trademark) may be used as the GPOS 105.

In this embodiment, as an example, a camera service app 106 is provided as the second app. The camera service app 106 uses the captured image data stored in a shared memory 107 by the camera control app 104 to execute a security process (details will be described later) to provide a service to ensure the security of the subject vehicle.

The firmware 108 is executed by a third core 23, and executes a boot process of the first MC 11 and activates and stops the first and second units 101, 102.

A part of the RAM 25 of the first MC 11 is configured as the shared memory 107 accessible by the first to third cores 21 to 23. The first and second units 101, 102 and the firmware 108 (i.e., the first to third cores 21 to 23) transmit and receive data via the shared memory 107. In addition to this, the first and second units 101 and 102 and the firmware 108 may transmit and receive data via the bus 28.

### 4. Operation Modes

The data collection device 2 is provided with at least a stop mode, a low power mode, and a service execution mode as operation modes.

The service execution mode is an operation mode in which a service can be provided by the data collection device 2, and the first MC 11 and the second MC 15 are operating. Note that while the subject vehicle is driving, the operation mode is the service execution mode.

The low power mode is an operation mode in which power consumption of the data collection device 2 is reduced by stopping some functions of the data collection device 2. In the low power mode, at least the first and second cores 21 and 22 (in other words, the first and second units 101 and 102) in the first MC 11 are stopped. In the present embodiment, for example, the first MC 11 is stopped in the low power mode. In the low power mode, at least a part of the functions of the second MC 15 is operating. Note that when the subject vehicle is stopped (for example, when the power switch or key switch of the subject vehicle is OFF), the operation mode is the low power mode. Specifically, for example, after the subject vehicle is parked and the occupant gets off the subject vehicle, the operation mode becomes the low power mode.

The stop mode 202 is a mode in which the operation of the data collection device 2 is stopped. In the stop mode, the operations of the first MC 11 and the second MC 15 are stopped. During the low power mode, when the voltage of the power source of the data collection device 2 decreases, the operation mode shifts to the stop mode. Specifically, for example, when the second MC 15 receives a signal indicating a decrease in the remaining amount of battery power during the low power mode, the operation mode shifts to the stop mode.

Then, when an operation to start driving the subject vehicle is performed during the low power mode, a start signal is input to the second MC 15. Further, during the low power mode, when the proximity sensor 5 detects an object such as a person approaching the subject vehicle, it outputs an activation signal to the second MC 15. In other words, the activation signal may be, for example, a signal that is received via the vehicle I/F 12 and indicates that a driving start operation has been performed, or a signal that is received from the proximity sensor 5 and indicates an object approaching the subject vehicle.

In addition to this, for example, when the communication unit 13 receives an activation instruction from the cloud 3 during the low power mode, it may output an activation signal to the second MC 15. Further, for example, during the low power mode, when the wireless LAN communication port or short-range wireless communication port of the vehicle I/F 12 receives the activation instruction from another electronic control unit via the wireless LAN or short-range wireless communication, it may output the activation signal to the second MC 15.

The second MC 15 to which the activation signal has been input outputs an activation control signal to the first MC 11 and activates the first MC 11. Thereby, the first unit 101 and the second unit 102 operated by the first MC 11 are activated, and the operation mode shifts from the low power mode to the service execution mode.

### 5. Activation by Proximity Sensor

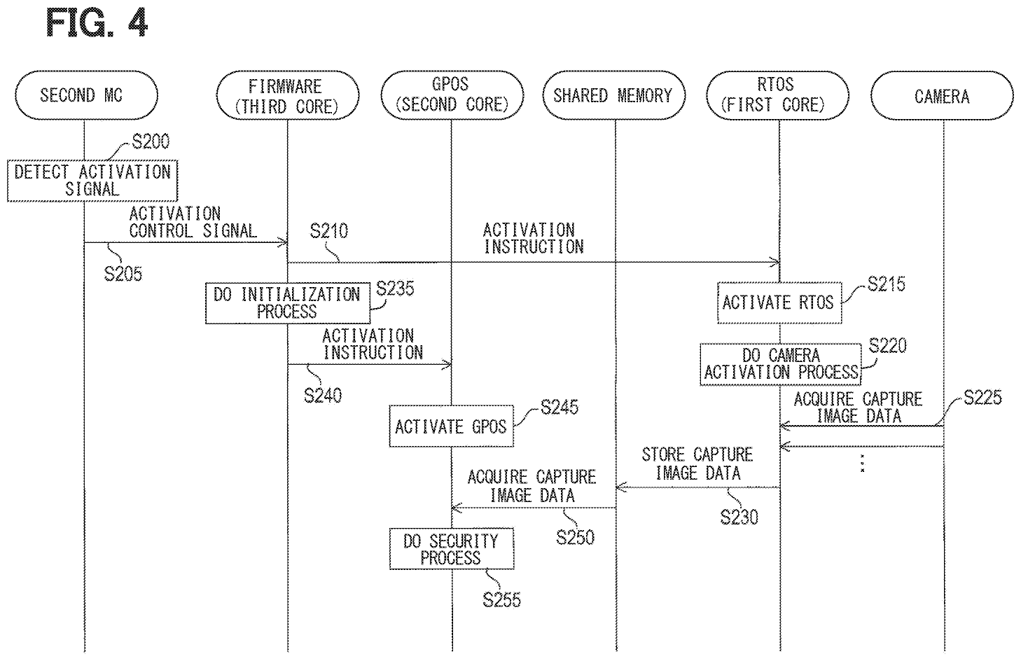

Next, a process during the low power mode will be described. In the process, the second MC 15 activates the first MC 11 in response to the activation signal from the proximity sensor 5 that has detected the approach of a person or the like, and the operation mode shifts to the service execution mode. More specifically, for example, the proximity sensor 5 outputs the activation signal when it detects a suspicious person attempting to steal or destroy a parked subject vehicle. When activated by the proximity sensor 5, the first MC 11 starts the capture by the camera 4 immediately after inputting the activation signal, so the first unit 101 is activated first, and then the second unit 102 is activated. Hereinafter, the process of activating the data collection device 2 in response to the input of the activation signal from the proximity sensor 5 during the low power mode will be described using the flowchart of FIG. 4.

During the low power mode, at least some of the functions of the second MC 15 are operating, and the second MC 15 is able to detect the input of the activation signal from the proximity sensor 5. When the second MC 15 detects the input of the activation signal (S200), it outputs the activation control signal to the first MC 11 (S205).

In the first MC 11 to which the activation control signal has been input, the firmware 108 operated by the third core 23 is activated, and a boot process of the first MC 11 starts. The firmware 108 instructs the first core 21 to activate the RTOS 103 (S210) before starting an initialization process (S235) to be described later. The first core 21 activates the RTOS 103 in response to the start instruction (S215).

Note that, as an example, it takes approximately 700 ms (milliseconds) for the first core 21 to activate the RTOS 103 (S215). Further, when the third core 23 is activated, the shared memory 107 is also activated, and access to the shared memory 107 becomes possible. In addition to this, for example, the firmware 108 may activate the RTOS 103 after the start of the initialization process (S235), which will be described later, but before the completion of the initialization process.

The RTOS 103 then executes a camera activation process (S220) and activates the camera control app 104. Thereby, the camera control app 104 is activated, and then the camera 4 is activated by the camera control app 104. Thereafter, the camera control app 104 continuously performs the capture with the camera 4, acquires the captured image data generated by the camera 4 (S225), and stores the acquired capture image data in the shared memory 107 (S230). As an example, it takes approximately 1 second after the first core 21 activates the activation of the RTOS 103 until the captured image data is first saved.

On the other hand, the firmware 108 executes the initialization process after activating the RTOS 103 (S235). In the initialization process, for example, the second unit 102 is initialized, such as loading a kernel of the GPOS 105 into the RAM 25, and a port of the second core 22 is set. When the initialization process is completed, the firmware 108 instructs the second core 22 to activate the GPOS 105 (S240). The second core 22 activates the GPOS 105 in response to the activation instruction (S245). Note that, as an example, it takes approximately 7 seconds for the second core 22 to activate the GPOS 105 (S245).

When the activation of the GPOS 105 is completed, the GPOS 105 activates the camera service app 106. The camera service app 106 converts the format (for example, resolution, compression rate, or the like) of the captured image data stored in the shared memory 107 into an appropriate format. Specifically, the camera service app 106 compresses the captured image data for storage, and executes a conversion process to a format suitable for image analysis, for example. Then, the camera service app 106 starts a security process for the subject vehicle based on the converted captured image data (S255). Note that the camera service app 106 executes the security process based on the captured image data generated from the activation time of the camera control app 104 until the activation time of the camera service app 106, and the captured image data generated after the activation of the camera service app 106.

In the security process, for example, a suspicious person may be detected by analyzing the captured image data, or suspicious person information may be specified by performing facial recognition of the detected suspicious person or estimation of the suspicious person's age, gender, or the like. For example, the suspicious person information and the captured image data of the suspicious person may be stored in the storage 14 or the like, or may be uploaded to the cloud 3. Further, for example, this information and state information indicating that the suspicious person has been detected may be transmitted to a mobile terminal of the user of the subject vehicle. Furthermore, when the suspicious person is detected, a warning sound may be outputted, for example, through a speaker (not shown).

In addition to this, in the security process, for example, a child left in a stopped subject vehicle may be detected by analyzing the captured image data. When the child left in the subject vehicle is detected, for example, a warning sound may be output, or the captured image data of the child in the subject vehicle may be periodically uploaded to the cloud 3.

In addition to the proximity sensor 5, the second microcomputer 15 may be connected to for example, an intrusion sensor that outputs the activation signal when it detects a suspicious person entering the subject vehicle, and a collision sensor that detects vibrations caused by a collision with the vehicle. Then, during the low power mode, when the activation signal is input from these sensors to the second MC 15, the first MC 11 may be activated in the same manner as when the activation signal is input from the proximity sensor 5.

Note that in the case where the first MC 11 is activated by the activation signal from the collision sensor, the object that collided with the subject vehicle may be identified in the security processing by analyzing the captured image data. Specifically, when a vehicle has collided with the subject vehicle, for example, the number, model, and the like of the vehicle that collided may be identified. The identified information and captured image data of the vehicle that collided may be stored in the storage 14 or the like, uploaded to the cloud 3, or transmitted to the mobile terminal or the like of the user of the subject vehicle.

### 6. Effect

According to the above embodiment, the following effects are obtained.

(1) According to the above embodiment, when the activation signal is input from the proximity sensor 5 or the like to the second MC 15, the firmware 108 activates the RTOS 103 before the completion of the initialization process, and activates the GPOS 105 after the completion of the initialization process. Therefore, after inputting the activation signal, the camera control app 104 can be activated early, and the camera 4 can start the capture. Then, the camera service application 106 executes the process based on the captured image data generated after the activation of the camera control app 104 and before the activation of the camera service app 106. Therefore, after the activation of the data collection device 2, it is possible to execute the process based on the image data captured by the camera 4 generated earlier.

(2) Further, the firmware 108 activates the RTOS 103 before starting the initialization process. Therefore, after inputting the activation signal, the camera control app 104 can be activated early, and the camera 4 can start the capture.

(3) Furthermore, the data collection device 2 executes the security process based on image data captured by the camera 4. Therefore, it is possible to satisfactorily provide services such as suspicious person detection.

(4) Furthermore, the captured image data of the camera 4 is stored in the shared memory 107, and the camera service app 106 executes the security process based on the captured image data stored in the shared memory 107. Therefore, the camera control app 104 can satisfactorily provide the captured image data to the camera service app 106.

(5) Furthermore, when the activation signal is input, in the first unit 101, the camera control app 104 is activated after the RTOS 103 is activated, and then the camera 4 is activated by the camera control app 104. Further, in the second unit 102, the camera service app 106 is activated after the GPOS 105 is activated. Therefore, it is possible to satisfactorily start the control of the camera 4 and the security process.

(6) Also, during the low power mode, the proximity sensor 5 outputs an activation signal to the second MC 15 when detecting the suspicious person or the like. The firmware 108 is then activated in response to the activation signal. Therefore, when it is detected that the suspicious person approaches the subject vehicle while the vehicle is stopped, it is possible to execute the security process based on the captured image data of the camera 4 generated earlier. Accordingly, it is possible to quickly start the highly urgent services such as suspicious person detection.

(7) Furthermore, when executing the security process, the camera service app 106 changes the format of the captured image data stored in the shared memory 107. Therefore, it is possible to satisfactorily execute the security process.

(8) Furthermore, the first unit 101 is executed by the first core 21 and the second unit 102 is executed by the second core 22. Therefore, it is possible to satisfactorily execute the control of the camera 4 and the security process based on the captured image data of the camera 4.

(9) Furthermore, the first unit 101 executes the process related to the hardware control, and the second unit 102 executes the process related to the service provision. Therefore, it is possible to satisfactorily control the devices installed in the subject vehicle, and also to provide services in cooperation with the cloud 3.

### Second Embodiment

### 1. Overall Configuration

The mobility IoT system 1 of the second embodiment has the similar configuration to the first embodiment, but differs from the first embodiment in the configuration of the data collection device 2.

That is, the data collection device 2 of the second embodiment differs from the first embodiment in that the first MC 11 includes the first and second cores 21 and 22 and does not include the third core 23. Therefore, various functions of the first MC 11 are implemented by the first and second cores 21 and 22 executing the control programs stored in the ROM 24 and RAM 25, which are non-transitional tangible storage medium.

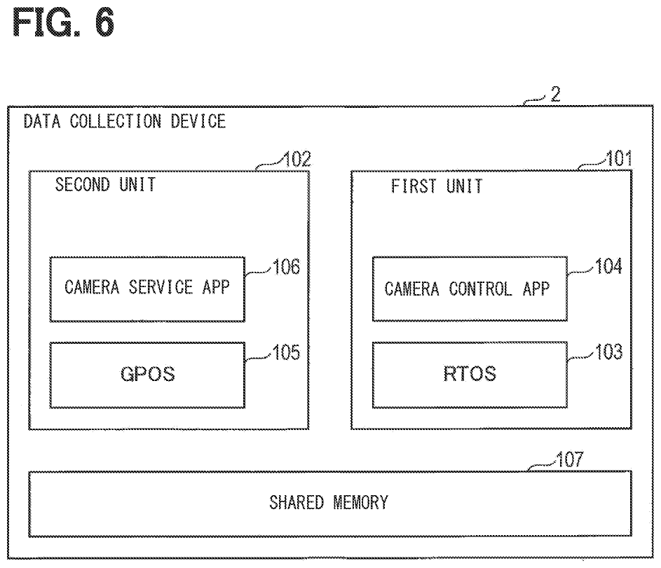

Further, the second embodiment differs from the first embodiment in that the control program stored in the ROM 24 includes the first and second units 101 and 102 and does not include the firmware 108 (see FIG. 6). Furthermore, in addition to the similar process to that in the first embodiment, the second embodiment differs from the first embodiment in that the first unit 101 executes a boot process that is a process for the first microcomputer 11 and executed by the firmware 108 in the first embodiment, and the like.

### 2. Activation by Proximity Sensor

Similarly to the first embodiment, the data collection device 2 of the second embodiment is provided with at least the stop mode, the low power mode, and the service execution mode as the operation modes. Then, similarly to the first embodiment, during the low power mode, the second MC 15 activates the first MC 11 in response to the activation signal from the proximity sensor 5 that has detected the approach of a person or the like, and the operation mode shifts to the service execution mode.

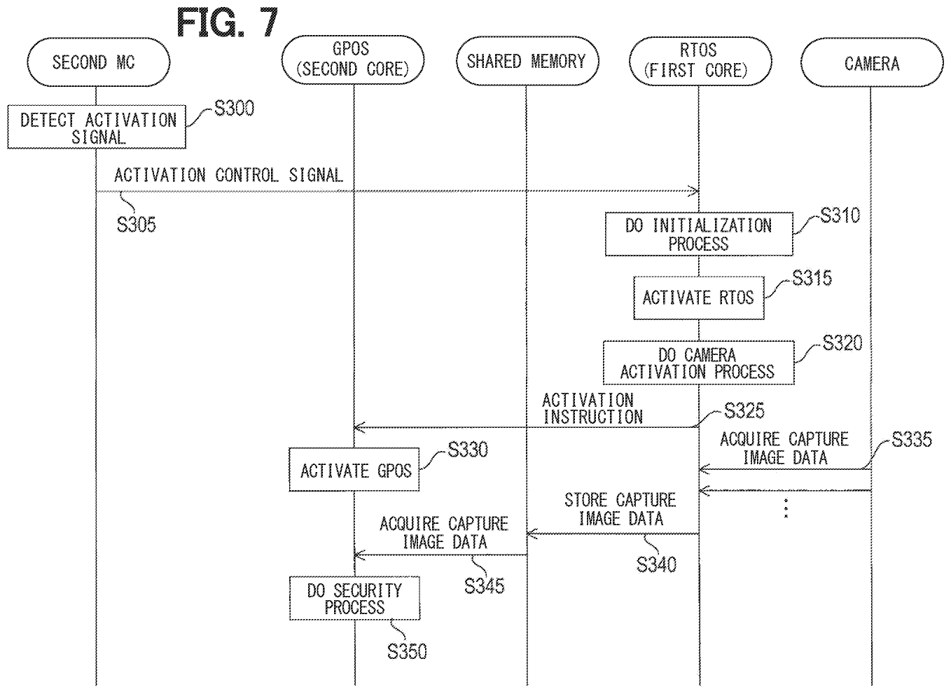

However, in the second embodiment, the first MC 11 is not provided with the firmware 108. Therefore, the data collection device 2 of the second embodiment differs from the first embodiment in the process of activating the data collection device 2 in response to the input of the activation signal from the proximity sensor 5 during the low power mode. Hereinafter, the process will be described with reference to the flowchart of FIG. 7.

Similarly to the first embodiment, during the low power mode, when the second MC 15 detects the input of the activation signal (S300), it outputs the activation control signal to the first MC 11 (S305). In the first MC 11 to which the activation control signal has been input, the first unit 101 starts the boot process. That is, after executing the initialization process (S310), the first unit 101 activates the RTOS 103 (S315). Thereafter, the RTOS 103 executes the camera activation process (S320) and activates the camera 4.

Note that the processes in S310 to S320 are similar to the processes in S235, S215, and S220 in the first embodiment, respectively. Further, after starting the first MC 11, the first unit 101 may immediately activate the RTOS 103, and then execute the initialization process on the RTOS 103.

The RTOS 103 then instructs the second core 22 to activate the GPOS 105 (S325). In response to the activation instruction, the second core 22 activates the GPOS 105 in the similar manner to the first embodiment (S330). Thereby, the second unit 102 is also activated. Note that when it takes time to activate the GPOS 105, the RTOS 103 may instruct the second core 22 to activate the GPOS 105 before or during the execution of the camera activation process.

Further, after executing the camera activation process, similarly to the first embodiment, the camera control app 104 continuously performs the capture with the camera 4, acquires the captured image data (S335), and stores the obtained captured image data in the memory 107 (S340).

Further, when the activation of the GPOS 105 is completed, the GPOS 105 activates the camera service app 106. Then, similarly to the first embodiment, the camera service app 106 starts a security process for the subject vehicle based on the converted captured image data (S345, S350). Immediately after the camera service app 106 is activated, the security process is executed based on converted image data generated before the activation of the GPOS 105.

### 3. Effects

According to the above embodiment, when the activation signal is input from the proximity sensor 5 or the like to the second MC 15, the first unit 101 executes the initialization process, the activation of the RTOS 103, and the camera activation process. Thereafter, the GPOS 105 is activated in response to an instruction from the RTOS 103, and the security process starts in the GPOS 105. Therefore, the RTOS 103 can be activated early after the activation signal is generated, and the camera 4 can start the capture. Then, the camera service application 106 executes the process based on the captured image data generated after the activation of the camera control app 104 and before the activation of the camera service app 106. Therefore, after the activation of the data collection device 2, it is possible to execute the process based on the image data captured by the camera 4 generated earlier.

### Other Embodiments

Although the embodiment of the present disclosure has been described above, the present disclosure is not limited to the embodiment described above, and various modifications can be made to implement the present disclosure.

(1) In the first embodiment, the first MC 11 of the data collection device 2 includes first to third cores 21 to 23, and in the second embodiment, the first MC 11 includes first and second cores 21 and 22. However, the number of physical cores in the first MC 11 is not limited to three, and may be appropriately determined.

More specifically, in the first embodiment, for example, a core that operates the firmware 108 may be provided in the data collection device 2, a virtual machine environment may be established, and the RTOS 103 and the GPOS 105 may be operated by one, three or more cores. In addition, for example, a virtual machine environment may be established, and the firmware 108, the RTOS 103, and the GPOS 105 may be operated by 2 or less cores or 3 or more cores.

Also in the second embodiment, for example, a virtual machine environment may be constructed and the RTOS 103 and GPOS 105 may be operated using one or more cores. Even in the case of having such a configuration, the RTOS 103 and the GPOS 105 can be activated in response to the activation signal during the low power mode in the similar manner to the above embodiment.

(2) In the first and second embodiments, a sensor other than the camera 4 may be provided to ensure the security of the subject vehicle. Specifically, the sensor may be, for example, a sensor such as a radar that detects objects existing in the periphery of the subject vehicle and/or within the vehicle. In the security process, suspicious person detection may be performed based on the detection data generated by the sensor instead of the image data captured by the camera 4. Even in the case of having such a configuration, a similar effect can be obtained.

(3) A plurality of functions of one element in the above embodiments may be implemented by a plurality of elements, or one function of one element may be implemented by a plurality of elements. Further, multiple functions of multiple components may be implemented by one component, or one function implemented by multiple components may be implemented by one component. A part of the configuration of the above embodiment may be omitted as appropriate. At least a part of the configuration of the above embodiment may be added to or substituted for the configuration of the other above embodiment.

(4) In addition to the data collection device 2 described above, the present disclosure may be implemented in various forms such as a program for causing a computer to function as the first MC 11 and the second MC 15 of the data collection device 2, a non-transitory tangible storage medium such as a semiconductor memory in which the program is stored, and a method implemented by the program. Further, for example, the present disclosure can be implemented in various forms such as a method implemented by the data collection device 2, a method implemented by the first MC 11 and/or the second MC 15, and a method of starting the data collection device 2.

### Correspondence of Terms

The data collection device 2 corresponds to an example of an in-vehicle device, and the first MC 11 of the data collection device 2 corresponds to an example of a first controller. Furthermore, the RTOS 103 corresponds to an example of a first OS, the GPOS 105 corresponds to an example of a second OS, the camera 4 corresponds to an example of a sensor, and the captured image data of the camera 4 corresponds to an example of detection data.

1. An in-vehicle device configured to access a cloud via a communication unit, the in-vehicle device comprising:
a controller that includes at least one physical core;
a first unit configured to be operated by the controller and control a sensor to generate detection data;
a second unit configured to be operated by the controller and execute a process based on the detection data; and
a firmware configured to be operated by the controller, be activated in response to an activation signal, and execute an initialization process,
wherein
when activated in response to the activation signal, the firmware activates the first unit before completion of the initialization process and activates the second unit after the completion of the initialization process,
when activated by the firmware, the first unit activates the sensor and controls the sensor to generate the detection data, and
when activated by the firmware, the second unit executes the process based on the detection data generated after activation of the first unit and before activation of the second unit.

2. The in-vehicle device according to claim 1, wherein
when activated in response to the activation signal, the firmware activates the first unit before starting the initialization process.

3. The in-vehicle device according to claim 1, wherein
the sensor is a camera, and
the detection data is a captured image data captured by the camera.

4. The in-vehicle device according to claim 1, further comprising
a shared memory that is accessible from the first unit and the second unit,
wherein
the first unit is configured to store the detection data in the shared memory, and
the second unit is configured to execute the process based on the detection data stored in the shared memory.

5. The in-vehicle device according to claim 1, wherein
the first unit includes a first application configured to control the sensor to generate the detection data, and a first operating system configured to operate the first application,
the second unit includes a second application configured to execute the process based on the detection data, and a second operating system configured to operate the second application,
in a case where the first unit is activated, after activation of the first operating system, the first application is activated,
after activation of the first application, the first application activates the sensor, and
in a case where the second unit is activated, after activation of the second operating system, the second application is activated.

6. The in-vehicle device according to claim 1, wherein
the in-vehicle device is configured to shift to a low power mode in which at least a part of a function of the in-vehicle device stops,
the activation signal is output when a proximity sensor mounted on a vehicle with the in-vehicle device detects approach of an object to the vehicle, and
in a case where the in-vehicle device is in the low power mode, when the proximity sensor outputs the activation signal, the firmware is activated.

7. The in-vehicle device according to claim 1, wherein
the second unit is configured to change a format of the detection data.

8. The in-vehicle device according to claim 1, wherein
the controller includes at least a first core and a second core that are a physical core,
the first core is configured to operate the first unit, and
the second core is configured to operate the second unit.

9. The in-vehicle device according to claim 1, wherein
the first unit is configured to execute a process related to hardware control, and
the second unit is configured to execute a process related to service provision.

10. A non-transitory computer-readable storage medium storing a control program configured to operate a computer as an in-vehicle device configured to access a cloud via a communication unit, the control program causing the computer to serve as:
a first unit configured to control a sensor to generate detection data;
a second unit configured to execute a process based on the detection data; and
a firmware configured to be activated in response to an activation signal, and execute an initialization process,
wherein
when activated in response to the activation signal, the firmware activates the first unit before completion of the initialization process and activates the second unit after the completion of the initialization process,
when activated by the firmware, the first unit activates the sensor and controls the sensor to generate the detection data, and
when activated by the firmware, the second unit executes the process based on the detection data generated after activation of the first unit and before activation of the second unit.

11. An activation method for an in-vehicle device configured to access a cloud via a communication unit, wherein
the in-vehicle device includes:
a controller that includes at least one physical core;
a first unit configured to be operated by the controller and control a sensor to generate detection data;
a second unit configured to be operated by the controller and execute a process based on the detection data; and
a firmware configured to be operated by the controller, be activated in response to an activation signal, and execute an initialization process,
when activated in response to the activation signal, the firmware activates the first unit before completion of the initialization process and activates the second unit after the completion of the initialization process,
when activated by the firmware, the first unit activates the sensor and controls the sensor to generate the detection data, and
when activated by the firmware, the second unit executes the process based on the detection data generated after activation of the first unit and before activation of the second unit.

12. An in-vehicle device configured to access a cloud via a communication unit, the in-vehicle device comprising:
a first controller that includes at least one physical core and is configured to stop activation in a low power mode;
a first unit configured to be operated by the first controller and control a sensor to generate detection data;
a second unit configured to be operated by the first controller and execute a process based on the detection data; and
a second controller configured to detect a predetermined signal in the low power mode,
wherein
when detecting the predetermined signal, the second controller activates the first unit,
when activated by the second controller, the first unit activates the second unit and the sensor, and controls the sensor to generate the detection data, and
when activated by the first unit, the second unit executes the process based on the detection data generated after activation of the first unit and before activation of the second unit.

13. A non-transitory computer-readable storage medium storing a control program configured to operate a computer as an in-vehicle device configured to access a cloud via a communication unit, the control program causing the computer to serve as:
a first unit configured to control a sensor to generate detection data; and
a second unit configured to execute a process based on the detection data,
wherein
in a low power mode, when a controller of the in-vehicle device detects a predetermined signal, the controller activates the first unit, when activated by the controller, the first unit activates the second unit and the sensor, and controls the sensor to generate the detection data, and
when activated by the first unit, the second unit executes the process based on the detection data generated after activation of the first unit and before activation of the second unit.

14. An activation method for an in-vehicle device configured to access a cloud via a communication unit, wherein
the in-vehicle device includes:
a first controller that includes at least one physical core and is configured to stop activation in a low power mode;
a first unit configured to be operated by the first controller and control a sensor to generate detection data;
a second unit configured to be operated by the first controller and execute a process based on the detection data; and
a second controller configured to detect a predetermined signal in the low power mode,
wherein
when detecting the predetermined signal, the second controller activates the first unit,
when activated by the second controller, the first unit activates the second unit and the sensor, and controls the sensor to generate the detection data, and
when activated by the first unit, the second unit executes the process based on the detection data generated after activation of the first unit and before activation of the second unit.

15. The in-vehicle device according to claim 1, further comprising:
a processor; and
a memory coupled to the processor and storing program instructions that when executed by the processor cause the processor to serve as the first unit, the second unit, and the firmware.

16. The in-vehicle device according to claim 12, further comprising:
a processor; and
a memory coupled to the processor and storing program instructions that when executed by the processor cause the processor to serve as the first unit and the second unit.
